(19) United States
(12) Patent Application Publication
(10) Pub. No.: US 2008/0071617 A1
(43) Pub. Date: Mar. 20, 2008

(54) Apparatus and methods for validating media

(76) Inventor: Lance Ware, North Tustin, CA (US)

Correspondence Address: GAZDZINSKI & ASSOCIATES;Attorney of Record, Suite 375, 11440 West Bernardo Court, San Diego, CA, 92127, US

(21) Appl. No.: 11/799,810

(22) Filed: May 2, 2007

Related U.S. Application Data
(60) Provisional application No. 60/818,019, filed on Jun. 29, 2006.

(51) Int. Cl. G06Q 30/00; G06F 17/00

(52) U.S. Cl. 705/14; 726/28

(57) ABSTRACT

Digital rights management apparatus and methods for use in computer, networking and other applications. In one embodiment, the digital rights management apparatus comprises an application and associated platform that allows users to validate a first version of their digital media. Upon validating that the digital media is indeed legal and authentic, the user is then given the ability to obtain a second version of the digital media. In another embodiment, the second version of the digital media differs in format from the first version of the digital media. In yet another embodiment, the digital rights management apparatus application is operated on a computing device in a client-server relationship with a database server. Methods for utilizing the aforementioned apparatus are also disclosed.

### PRIORITY

This application claims priority to U.S. provisional patent application Ser. No. 60/818,019 of the same title filed Jun. 29, 2006, which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to digital rights media management, and specifically in one embodiment to system and apparatus for verifying the authenticity of physical media such as to, e.g., allow a consumer to obtain secondary versions of the original content, whether in the same or a different format.

### DESCRIPTION OF RELATED TECHNOLOGY

Today, there is an ongoing change in the way content is allowed to be distributed by content owners to consumers. Traditionally, content has been delivered on a physical medium such as cassette or DVD to the consumer. In the future, the physical mediums available to purchasers of content will include such standards such as HD-DVD and Blu-Ray, Silicon Storage (e.g. Secure Digital, Memory Stick and Compact Flash) and yet to be realized technologies such as optical holographic cubes or the like.

Traditionally, content owners use retail stores and other distribution methods (e.g., mail delivery) to deliver these physical media to the consumer. A license or right to view or playback that content is typically conferred with the purchase of legitimate content. In addition, these licenses are transferable if the owner were to sell or give the original DVD to another party. However, piracy has become a major issue for the content owners as the ability for unscrupulous computer owners to illegally and with relative ease redistribute unlicensed copies without the physical media or in a so-called “soft copy”.

Existing Digital Rights Management (DRM) technology is generally made up of robust encryption algorithms (often utilizing both public key cryptography as well as shared secrets), in addition to tamper-proofing technologies. For example, the Data Encryption Standard (DES) technique or Advanced Encryption Standard (AES) may be used to secure content.

DES is a well-known symmetrical cipher that utilizes a single key for both encryption and decryption of messages. Because the DES algorithm is publicly known, learning the DES key would allow an encrypted message to be read by anyone. As such, both the message sender and receiver must keep the DES key a secret from others. A DES key typically is a sequence of eight bytes, each containing eight bits. To enhance the DES integrity, the DES algorithm may be applied successive times. With this approach, the DES algorithm enciphers and deciphers data, e.g., three times in sequence, using different keys, resulting in a so-called triple DES (3DES) technique.

The Advanced Encryption Standard (AES), also known as Rijndael, is a block cipher adopted as an encryption standard by many entities including the U.S. government. It is used worldwide, as is the case with its predecessor, DES. AES was adopted by National Institute of Standards and Technology (NIST) and was codified as US FIPS PUB 197 in November 2001. AES has a fixed block size of 128 bits and a key size of 128, 192 or 256 bits. The key is expanded using the well-known Rijndael key schedule. Most of AES calculations are performed in a special finite field. AES typically operates on a 4×4 array of bytes, termed the state.

AES provides a much higher level of encryption than DES or 3DES, and hence is increasingly being integrated into applications where strong protection is desired, including the delivery of content over cable or other content-based networks.

In contrast to the DES or AES techniques, a public key encryption technique, e.g., an RSA technique (named for its developers, Rivest, Shamir, and Adleman), uses two different keys. A first key, referred to as a private key, is kept secret by a user. The other key, referred to as a public key, is available to anyone wishing to communicate with the user in a confidential manner. The two keys uniquely match each other, collectively referred to as a “public \-private key pair.” However, the private key cannot be easily derived from the public key.

Other approaches to DRM are known in the prior art. For example, U.S. Pat. No. 6,327,652 to England, et al. issued Dec. 4, 2001 entitled “Loading and identifying a digital rights management operating system”, discloses determining the identity of an operating system running on a computer from an identity associated with an initial component for the operating system, combined with identities of additional components that are loaded afterwards. Loading of a digital rights management operating system on a subscriber computer is guaranteed by validating digital signatures on each component to be loaded and by determining a trust level for each component. A trusted identity is assumed by the digital rights management operating system when only components with valid signatures and a pre-determined trust level are loaded. Otherwise, the operating system is associated with an untrusted identity. Both the trusted and untrusted identities are derived from the components that were loaded. Additionally, a record of the loading of each component is placed into a boot log that is protected from tampering through a chain of public-private key pairs.

U.S. Pat. No. 6,591,365 to Cookson issued Jul. 8, 2003 and entitled “Copy protection control system” discloses a system for protecting against use of pirated music. Two watermarks are inserted into the music to be protected by the music publisher. One watermark is robust—it will not be destroyed by compression. The other watermark is weak—it is designed to be destroyed by compression. The robust mark tells a player that the music is protected, i.e., that it is not authorized to be delivered in compressed form over an insecure channel. If the music is found to have been compressed and it was delivered over an insecure channel, then its play or other processing can be restricted.

U.S. Pat. No. 6,775,655 to Peinado, et al. issued Aug. 10, 2004 and entitled “Rendering digital content in an encrypted rights-protected form”, discloses a rendering application determines that digital content is in an encrypted rights-protected form and invokes a Digital Rights Management (DRM) system which includes a license store having at least one digital license stored therein. Each license corresponds to a piece of digital content and includes a decryption key (KD) for decrypting the corresponding digital content. The DRM system locates each license in the license store corresponding to the digital content to be rendered, selects one of the located licenses, obtains (KD) from the selected license, decrypts the digital content with (KD), and returns the decrypted digital content to the rendering application for actual rendering.

U.S. Pat. No. 6,820,063 to England, et al. issued Nov. 16, 2004 and entitled “Controlling access to content based on certificates and access predicates” discloses specifying digital rights for content downloaded to a subscriber computer from a provider in an access predicate. The access predicate is compared with a rights manager certificate associated with an entity, such as an application, that wants access to the content. If the rights manager certificate satisfies the access predicate, the entity is allowed access to the content. A license that specifies limitations on the use of the content can also be associated with the content and provided to the entity. The use the entity makes of the content is monitored and terminated if the entity violates the license limitations. In one aspect of the invention, the access predicate and the license are protected from tampering through cryptographic techniques.

U.S. Pat. No. 6,996,720 to DeMello, et al. issued Feb. 7, 2006 and entitled “System and method for accessing protected content in a rights-management architecture”, discloses a digital rights management system for the distribution, protection and use of electronic content. The system includes a client architecture which receives content, where the content is preferably protected by encryption and may include a license and individualization features. Content is protected at several levels, including: no protection; source-sealed; individually-sealed (or “inscribed”); source-signed; and fully-individualized (or “owner exclusive”). The client also includes and/or receives components which permit the access and protection of the encrypted content, as well as components that allow content to be provided to the client in a form that is individualized for the client. In some cases, access to the content will be governed by a rights construct defined in the license bound to the content. The client components include an object which accesses encrypted content, an object that parses the license and enforces the rights in the license, an object which obtains protection software and data that is individualized for the client and/or the persona operating the client, and a script of instructions that provides individualization information to a distributor of content so that the content may be individualized for the client and/or its operating persona. Content is generally protected by encrypting it with a key and then sealing the key into the content in a way that binds it to the meta-data associated with the content. In some instances, the key may also be encrypted in such a way as to be accessible only by the use of individualized protection software installed on the client, thereby binding use of the content to a particular client or set of clients.

As exemplified in the prior art DRM systems discussed above, the typical components of a prior art DRM system include: (1) packaging technology (used to encrypt the content); (2) client side technology (usually components or fully built media players such as Real Player™, Windows Media Player™, etc.); and (3) license server technology (used to generate “licenses” to decrypt content using the client side technology).

However, despite the foregoing, most DRM implementations to date have little to no interaction with physical media. While these technologies allow for a wide array of business models, the DRM technology itself is not generally responsible for validation of the user's right to utilize any given piece of content. As such, business models involving the out right sale of “soft” content are relatively limited in their capabilities. One can for instance “sell” a full-length feature film for $14.95; however it is not currently possible to offer a discount to a customer that already owns a physical copy of the same content in a robust and reliable manner, especially if the soft copy is to be sold at a different point in time from the physical good.

Accordingly, what is needed are a system and methodologies for allowing users of digital content to authenticate their purchased versions with a digital rights management or other such entity, thereby allowing these users to purchase “soft” copies of this content at a discounted cost.

In addition, it is desirable for users to be allowed to obtain secondary versions of their digital content in both original and alternative formats.

### SUMMARY OF THE INVENTION

The present invention satisfies the foregoing needs by providing apparatus and methods for management of digital rights and content-bearing media.

In a first aspect of the invention, a digital rights management apparatus comprising an application is disclosed. In one embodiment, the digital rights management application comprises a substantially computerized system that is adapted to validate the authenticity of a first version of a digital media, and in response to this validation process, allow a user to purchase or download a second version of the digital media.

In one variant, the validation comprises performing a cryptographic hash of at least a portion of the digital media.

In another variant, the first version comprises an optical pressed medium, and the validation comprises evaluating wobble-track information.

In yet another variant, the first version comprises a compact disc (CD), and the validation comprises evaluating serial copy management system flag information.

In still another variant, the validation comprises the application of two digital watermarks, wherein one of the watermarks exists only in an original version of the digital media.

In another variant, the validation comprises detecting the presence of valid content scrambling system protected content on a physical medium, without actually accessing content scrambled by the scrambling system.

In yet another embodiment of the apparatus, the digital rights management apparatus comprises a computing device comprising a digital processor and an application running on the digital processor. The application is adapted to authenticate digital content provided to the computing device thereby permitting a user to obtain access to soft copies of the digital content via the computing device.

In a second aspect of the invention, methods for validation of the authenticity of digital media are disclosed. In one embodiment, the method comprises providing said digital media to an application, at least a portion of said application running on a computing device; generating a first characterization of said digital media using said application; evaluating said first characterization of said digital media in light of a second characterization in order to authenticate said digital media; and providing one or more options to said user should said digital media be authenticated. In one variant, the one or more options comprises permitting a user to obtain a soft copy of the digital media content.

In a third aspect of the invention, a physical medium (e.g., DVD or CD or laserdisc) is disclosed having digital rights and authenticity validation information associated therewith. In one embodiment, the physical medium comprises digital content and a portion of a validation application. The validation application is operable to authenticate the digital content thereby permitting a user to retrieve a soft copy of the digital content upon authentication.

In a fourth aspect of the invention, business methods and apparatus making use of the foregoing system, methods and medium are disclosed.

In one embodiment, a method of doing business is disclosed, comprising providing, pursuant to a purchase or sales transaction, a physical medium operable with a digital rights management system, the medium comprising digital content; and providing a coupon or stored value token for the purchase or sales transaction, the coupon or token allowing a purchases of the physical medium to utilize content authentication services over a network. In one variant, the act of providing a coupon or stored value comprises providing the coupon or stored value on the physical medium itself. In another variant the act of providing a physical medium comprises providing at least a portion of a validation application on the medium, the validation application operable to authenticate the digital content, thereby permitting a user to retrieve a soft copy of the digital content upon authentication of the digital content. In still another variant, the coupon or stored value is associated uniquely with a particular retailer or sales entity.

In another embodiment, the method comprises generating revenue related at least in part to the distribution of copies of user's previously purchased digital content without charging the user for downloading secondary versions of the user's digital content. In one variant, the revenue is generated based at least in part on user-provided profile or demographic information, the information being provided as part of the downloading. The information is used at least for substantially targeted advertising, the advertising generating the revenue for an on-line provider that provides the distribution of the copies.

In a fifth aspect of the invention, a network server apparatus useful for validating media or content is disclosed.

In a sixth aspect of the invention, a database apparatus useful for validating media or content is disclosed.

### BRIEF DESCRIPTION OF THE DRAWINGS

The features, objectives, and advantages of the invention will become more apparent from the detailed description set forth below when taken in conjunction with the drawings, wherein:

FIG. 1 is a logical flow diagram illustrating a first exemplary apparatus for validating the authenticity of a user's digital content.

FIG. 2 is a logical flow diagram illustrating an exemplary system apparatus for validating the authenticity of a user's digital content and providing mechanisms for the sale or download of secondary versions of the digital content.

FIG. 3 is a logical flow diagram illustrating a first exemplary methodology for providing secondary versions of content dependent on the validation of a first version.

### DETAILED DESCRIPTION OF THE PREFERRED EMBODIMENT

Reference is now made to the drawings wherein like numerals refer to like parts throughout.

As used herein, the term “application” refers generally to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment; for example, the unit could comprise a downloadable Java Xlet™ that runs within the JavaTV™ environment.

As used herein, the terms “computer program”, “routine,” and “subroutine” are substantially synonymous, with “computer program” being used typically (but not exclusively) to describe collections or groups of the latter two elements. Such programs and routines/subroutines may be rendered in any language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

As used herein, the terms “computing device”, “client device”, and “end user device” include, but are not limited to, personal computers (PCs) and minicomputers, whether desktop, laptop, or otherwise, set-top boxes such as the Motorola DCT2XXX/5XXX and Scientific Atlanta Explorer 2XXX/3XXX/4XXX/8XXX series digital devices, personal digital assistants (PDAs) such as the Blackberry® or “Palm®” family of devices, handheld computers, personal communicators, J2ME equipped devices, cellular telephones, or literally any other device capable of interchanging data with a network. As used herein, the terms “content” and “media” are used interchangeably to refer to, without limitation, multimedia, video, data, games, computer applications, files, DRM, steganographic, or cryptographic elements, whether stored or recorded, or ephemeral in nature.

As used herein, the term “digital processor” is meant generally to include all types of digital processing devices including, without limitation, digital signal processors (DSPs), reduced instruction set computers (RISC), general-purpose (CISC) processors, microprocessors, gate arrays (e.g., FPGAs), Reconfigurable Compute Fabrics (RCFs), and application-specific integrated circuits (ASICs). Such digital processors may be contained on a single unitary IC die, or distributed across multiple components.

As used herein, the term “integrated circuit (IC)” refers to any type of device having any level of integration (including without limitation ULSI, VLSI, and LSI) and irrespective of process or base materials (including, without limitation Si, SiGe, CMOS and GAs). ICs may include, for example, memory devices (e.g., DRAM, SRAM, DDRAM, EEPROM/Flash, ROM), digital processors, SoC devices, FPGAs, ASICs, ADCs, DACs and other devices, as well as any combinations thereof.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “network” refers generally to any system having two or more nodes that is capable of carrying data or other signals and/or power. Examples of networks include, without limitation, LANs (e.g., Ethernet, Gigabit Ethernet, etc.), WANs, PANs, MANs, internets (e.g., the Internet), intranets, HFC networks, etc. Such networks may comprise literally any topology (e.g., ring, bar, star, distributed, etc.) and protocols (e.g., ATM, X.25, IEEE 802.3, IP, etc.), whether wired or wireless for all or a portion of their topology.

As used herein, the term “optical media” refers to any physical medium which contains information (usually digital) that is typically written and read by a laser or other light source. Examples of optical media include, without limitation, Laserdiscs, Compact Disc/CD-ROM, CD-R, CD-RW, MiniDisc™, DVD, DVD−R, DVD−R DL, DVD+R, DVD+R DL, DVD−RW, DVD+RW, DVD+RW DL, DVD-RAM, Blu-ray™ Disc, BD-R, BD-RE, HD DVD, HD DVD−R and UDO (Ultra Density Optical Disc).

As used herein, the term “purchase” shall mean without limitation any sale, agreement for sale, transfer of funds, promise to transfer funds, barter arrangement, promotional or incentive agreement or arrangement, or other relationship wherein consideration of any kind is exchanged between two or more parties (or their proxies).

As used herein, the term “recording medium” refers to any material, component, collection of components or device adapted to store information in a substantially permanent or semi-permanent state. Exemplars of recording media include, without limitation, magnetic media, integrated circuits (e.g., RAM or ROM), optical media, chemical media, and atomic- and subatomic-level storage structures (e.g., crystalline structures, quantum or spin states, etc.).

As used herein, the terms “retail” and “retailer” refer to any entity, person, or system/location (or collection or combination thereof, such as e.g., in the case of a retail distribution chain) that offers content or media for distribution (whether via sale-for-profit, gratuitously, as part of an incentive or subscription program, or otherwise), including without limitation rental/purchase distributors (Blockbuster, NetFlix), download service (e.g., Apple/iTunes, Microsoft Music), Cinema Now, etc.

As used herein, the term “server” refers generally to any computing device capable of being accessed over a network as those terms were previously defined.

Overview

Digital rights management technology allows, inter alia, the owners of content to control whether secondary copies of an original digital media can be obtained. For instance, digital rights management technology is utilized to prevent the unlawful copying of movies, music albums, computer software and other forms of media. The present invention allows providers of content to, inter alia, control their copyrighted works so that customers or users may legally acquire copies of owned original work. These copies may be of a similar originating format, or alternatively may be converted into an alternative format suitable for other devices. For example, a purchaser of a compact disc (“CD”) may wish to “rip” the music from the CD medium and place it onto a portable music player such as an iPod® device manufactured by Apple Inc. The digital media format needed in order for the music to be played on the iPod requires conversion from the native CD format (e.g. the “Red Book”/Sony/Philips standard) to any plurality of supported iPod formats such as MP3, WAV, M4A/AAC, protected AAC and AIFF.

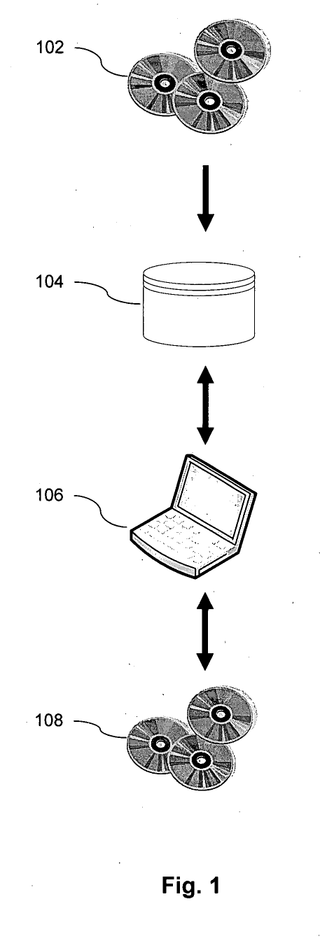

As shown in FIG. 1, the present invention allows owners or distributors of original content to provide original copies of the physical media 102 that will be stored in a database 104 so that characteristics of the original copies may be characterized for later comparison checks. Alternatively, digital signatures or other protective or cryptographic elements related to the media may be stored so as to save space as compared to storing the entire media. A user thus seeking to authenticate his/her legally obtained content in order to obtain (whether via purchase, assignment or otherwise) copies in an alternative or secondary media format, may then simply provide his/her own physical media 108 to a computing device 106 attached to the database 104 via, e.g., a direct interface, a client-server or other networked relationship. The computing device 106 then can query the storage database 104 and perform validation checks on the user's media 108 in order to validate the content, thus allowing the user to obtain copies of the original content 108 in a same or alternative format with the owner or distributor assured that the original media was in fact authentic.

Digital Rights Management

Exemplary embodiments of the invention are now described in detail. It is noted that while portions of the following description are cast primarily in terms of the validation of optical physical media (e.g. DVD's or optical discs) the invention is by no means so limited.

Furthermore, while certain embodiments are cast in terms of validation procedures for specific types of physical media, these specific examples are for purposes of clarity and many of the principles could apply equally well to other forms of media, whether in soft copy or hard copy form. Accordingly, the following discussion is merely exemplary of the broader concepts.

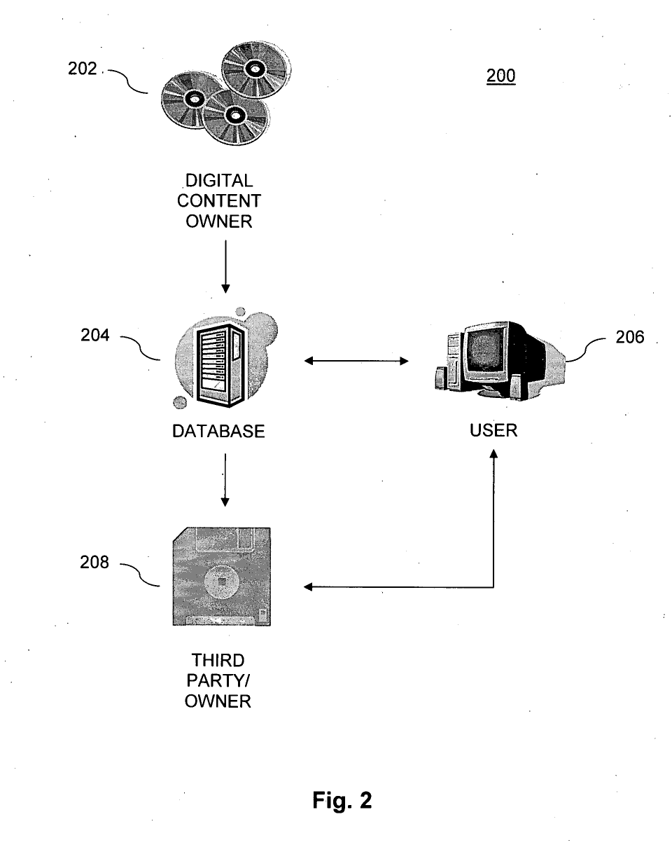

Referring now to FIG. 2, an exemplary configuration of a digital rights management system 200 according to the principles of the present invention is shown. The system 200 includes a digital content owner apparatus 202 that has the ability to provide digital content information to a database 204 or other data storage repository. The apparatus 202 could include any number of schemes and methods for implementing such functionality including for example, a direct computer interface (e.g., USB or IEEE-1394 interface with a computerized device where the digital content information is stored, or a client-server relationship between the digital content owner and the database 204, thus allowing the digital content owner to provide original content (or portions or derivations thereof) to the database for validation processing. The apparatus 202 could also include less sophisticated methods such as simply hand delivering or mailing original media content to the provider of the database so that the content can be stored onto the database apparatus 204. A third party or proxy may also provide the media content (via whatever mechanism) on behalf of the owner. For example, in one variant, the store where the purchaser obtained the original media might maintain an electronic version thereof, and knowing that the purchaser did in fact purchase the content, allow for their version of the content to be provided to the database 204, such as upon request from a user with a proper purchase proof or authentication code, etc.

Numerous techniques are known for implementing Digital Rights Management (DRM) technology, many of which may be implemented in conjunction with the present invention. For example, U.S. Pat. No. 6,327,652 to England, et al. issued Dec. 4, 2001 entitled “Loading and identifying a digital rights management operating system”, incorporated herein by reference in its entirety, discloses determining the identity of an operating system running on a computer from an identity associated with an initial component for the operating system, combined with identities of additional components that are loaded afterwards. Loading of a digital rights management operating system on a subscriber computer is guaranteed by validating digital signatures on each component to be loaded and by determining a trust level for each component. A trusted identity is assumed by the digital rights management operating system when only components with valid signatures and a pre-determined trust level are loaded. Otherwise, the operating system is associated with an untrusted identity. Both the trusted and untrusted identities are derived from the components that were loaded. Additionally, a record of the loading of each component is placed into a boot log that is protected from tampering through a chain of public-private key pairs.

U.S. Pat. No. 6,775,655 to Peinado, et al. issued Aug. 10, 2004 and entitled “Rendering digital content in an encrypted rights-protected form”, incorporated herein by reference in its entirety, discloses a rendering application determines that digital content is in an encrypted rights-protected form and invokes a Digital Rights Management (DRM) system which includes a license store having at least one digital license stored therein. Each license corresponds to a piece of digital content and includes a decryption key (KD) for decrypting the corresponding digital content. The DRM system locates each license in the license store corresponding to the digital content to be rendered, selects one of the located licenses, obtains (KD) from the selected license, decrypts the digital content with (KD), and returns the decrypted digital content to the rendering application for actual rendering.

U.S. Pat. No. 6,820,063 to England, et al. issued Nov. 16, 2004 entitled “Controlling access to content based on certificates and access predicates” incorporated herein by reference in its entirety discloses specifying digital rights for content downloaded to a subscriber computer from a provider in an access predicate. The access predicate is compared with a rights manager certificate associated with an entity, such as an application, that wants access to the content. If the rights manager certificate satisfies the access predicate, the entity is allowed access to the content. A license that specifies limitations on the use of the content can also be associated with the content and provided to the entity. The use the entity makes of the content is monitored and terminated if the entity violates the license limitations. In one aspect of the invention, the access predicate and the license are protected from tampering through cryptographic techniques.

U.S. Pat. No. 6,996,720 to DeMello, et al. issued Feb. 7, 2006 entitled “System and method for accessing protected content in a rights-management architecture”, incorporated herein by reference in its entirety, discloses a digital rights management system for the distribution, protection and use of electronic content. The system includes a client architecture which receives content, where the content is preferably protected by encryption and may include a license and individualization features. Content is protected at several levels, including: no protection; source-sealed; individually-sealed (or “inscribed”); source-signed; and fully-individualized (or “owner exclusive”). The client also includes and/or receives components which permit the access and protection of the encrypted content, as well as components that allow content to be provided to the client in a form that is individualized for the client. In some cases, access to the content will be governed by a rights construct defined in the license bound to the content. The client components include an object which accesses encrypted content, an object that parses the license and enforces the rights in the license, an object which obtains protection software and data that is individualized for the client and/or the persona operating the client, and a script of instructions that provides individualization information to a distributor of content so that the content may be individualized for the client and/or its operating persona. Content is generally protected by encrypting it with a key and then sealing the key into the content in a way that binds it to the meta-data associated with the content. In some instances, the key may also be encrypted in such a way as to be accessible only by the use of individualized protection software installed on the client, thereby binding use of the content to a particular client or set of clients.

The exemplary database apparatus 204 of FIG. 2 comprises one or more servers with at least one of the servers containing stored “original” digital content media information. A RAID array or other similar device may also be implemented for redundancy and fail-over reliability. One exemplary system useful with the invention is the Exastore™ system manufactured by Exanet, Inc., although other devices and architectures can be utilized. See, e.g., U.S. Pat. No. 6,934,880 to Hofner issued Aug. 23, 2005 and entitled “Functional fail-over apparatus and method of operation thereof”, incorporated herein by reference in its entirety, which describes the aforementioned Exastore system in detail.

Moreover, RAID systems are currently being deployed within a single or unitary computer device; e.g., software performs RAID 0, RAID 1, etc. storage or “striping” using multiple storage devices indigenous to a single computer. These provide RAID capability to the average consumer at very low cost.

The stored original digital content information could either comprise the entire original digital content, or alternatively could comprise only a portion of the original content and/or one or more “fingerprints” of the original content. In one context, such a fingerprint(s) might comprise a derivative or cryptographic “hash” of certain portions of the data, as described in greater detail subsequently herein. In this context, the term “hash” refers to a one-way algorithm the result of which cannot be used to determine the original constituent inputs, yet which is unique. Other cryptographic derivations or algorithms may be used as well, however, consistent with the basic principles of “fingerprinting” all or portions of the content.

Optionally, the database apparatus 204 may also comprise a digital processor (e.g., security processor or the like) that can compare the original digital media content provided by the digital content owner with user content digital media to validate the user's digital media. The database apparatus 204 will preferably operate in a client-server relationship between the user apparatus 206, whether directly or indirectly, so that original digital media content may be compared with the content attempting to be validated at the user apparatus 206. In some embodiments, the database/content storage apparatus 204 will also comprise a digital processor for reading digital media content from a user apparatus 206, and a software application (computer program) running on a digital processor for determining whether the digital media content from a user apparatus 206 is from a valid original source or not.

The user apparatus 206 may comprise any number of client or end user devices capable of reading digital media content. As examples, the user apparatus 206 may comprise a DVD drive that is also capable of reading CD media, a digital video recorder (DVR), and a USB drive or key. In one embodiment, the user apparatus 206 will also be able to communicate bi-directionally over a network with the database apparatus 204 to retrieve information about original digital media content. Alternatively, the user device 206 may also contain means for transmitting information about a user's digital media content to the database 204, such as wireline or wireless network interface with associated protocol stack by which the data or messages can be sent. In either alternative, validation procedures for validating the authenticity of the user's digital media content will occur either at the user apparatus 206, database apparatus 204 or a combination of both. A proxy entity (e.g., web server or the like) may also be utilized for this purpose.

The present invention also contemplates the use of a distributed application (DA) of the type well known in the software arts; such DA's may comprise for example a client portion and a server portion which are in communication with one another over the interposed bearer network, and which coordinate the performance of certain tasks via such communication. This approach allows the client device to be comparatively “thin” as compared to other architectures, since much of the application's functionality is disposed on the server portion.

In one embodiment, the third party apparatus 208 comprises one or more servers in a network that are capable of communicating with a user apparatus 206 and/or a database/content storage apparatus 204. The third party apparatus 208 will comprise stored digital content in alternative formats and is capable of transmitting requested digital content to a user apparatus 206 should a user's digital media have been properly validated. This validation may be received either directly from the user apparatus 206, or alternatively via the database apparatus 204 (e.g., in conjunction with a validation server or validation service) or even a network or third-party proxy (e.g., content delivery network such as a cable or satellite network/MSO, or even a P2P network).

In another embodiment, the third party apparatus 208 comprises conversion software (or firmware/hardware) that receives original digital media content from the database or content storage apparatus 204 and/or associated content server, or a third party source and converts this original digital media into a requested format for the user apparatus 206, such as where transcoding from a first coded format to a second encoded is used (e.g., transcoding Windows Media to Real or AVC formats).

While discussed primarily as a third party apparatus 208, such third party ownership or operation is not a requirement. In fact, the “third party” apparatus may be owned and operated by the digital content owner themselves, or could in fact be an extension of the database or content storage apparatus and associated server 204. Further, the third party apparatus could comprise a software application running on the user apparatus 206, permitting the user to convert his/her content to a requested format after validation. A myriad of other possibilities would be readily apparent to one of ordinary skill given the present disclosure herein.

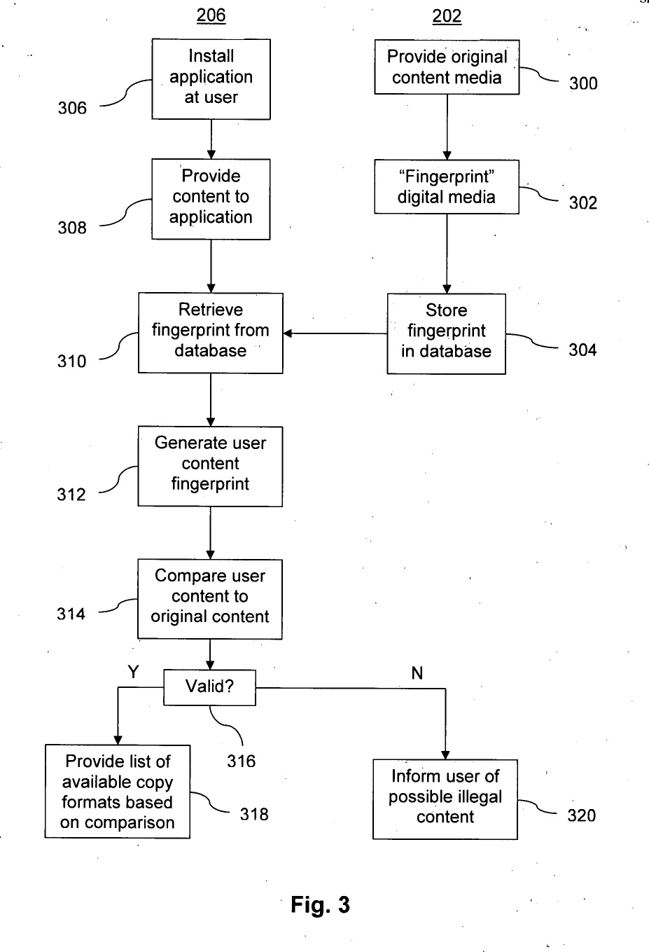

Referring now to FIG. 3, one exemplary methodology for providing enhanced digital rights media management capabilities to original owners of digital content is described.

At a high level, the methodology generally comprises: (i) providing content; and (ii) comparing portions of that content (or “fingerprints” or derivations thereof) against second content to assess its validity. However, FIG. 3 describes one specific implementation thereof for purposes of illustration.

At step 300, original media content is provided. The original content can be provided in its native format, i.e. if the original content is a DVD movie, then the content will be provided to the digital rights management entity or digital database in the form of a DVD disk, and appropriately encoded. Alternatively, a soft copy of the original digital content can be provided to the digital rights management entity. However, this soft copy should be representative of the content form of a user's digital media, so that a valid comparison can be performed. Providing a soft copy. (including any ancillary data or information necessary to provide the requisite cryptographic key data, etc.) has the advantage that original content can be transmitted to the digital rights management entity purely over a network or other electronic delivery mechanism, without the need to handle physical media. This may be accomplished over any number of known ways, including for example a client-server network relationship between the original content media owner and the digital rights management entity.

At step 302, the original digital media content is “fingerprinted” by the digital rights management entity. Here, the original digital media content will be pre-processed according to any number of validation procedures as will be discussed further herein. For example, the original digital media or portions thereof may be “hashed”, or a file manifest determined based on an analysis of the original digital media. This information can then be stored in a database at step 304 for later retrieval by a user application program or alternatively may be stored for later user content validation at the database site. Note that step 302 may also be performed by the digital content owner or a third party (e.g., post production house, MSO, etc.) and the “fingerprint” data may then be sent directly to the digital rights management entity. Because the “fingerprinted” data will almost always comprise data of much smaller size then the original content itself, this method has an advantage in that large volumes of data need not be necessarily transmitted over a network.

At step 306, application software is installed at a user device. As will be appreciated by those of ordinary skill, there are several possibilities for implementing such a step. In one embodiment, and perhaps the easiest method technically to implement, the computer application software is installed on the user media content (e.g., DVD or CD) itself. The application can be set to auto-run once the user media has been inserted into a computing device, or alternatively it may require some sort of user interaction (e.g. double-click of an icon, etc.) in order to initiate the application software. Upon initiation of the application, the application will validate the user's digital media by running one or more validation procedures on the media while communicating over a client-server relationship with the original digital media database. In addition, at least part of the application may be installed onto the user's client device. The application may then, via an internet connection, support “self-updating” of the application software to update the application to address various kinds of software updates. This method has the advantage that any potential compatibility issues may be addressed up front, thereby eliminating or minimizing problems that may be encountered by a user of the software application.

In another embodiment, the user may purchase and/or download and install the application onto their computer in order to receive services related to their digital media content. This embodiment has the advantage of allowing for validation of user media that existed prior to the development of the application program or simply for purposes of avoiding the dedication of space on the user's digital media content for the validation application program.

In yet another embodiment, the user may elect to purchase and/or download soft copy content at an enabled retailer's website, or other network node or location (e.g., kiosk, retail store, or via a content-based network). If the content owner has made such content available and requires validation of the user's digital media, the user will be prompted to download the validation application software from the retailer's website (or obtain it in another fashion, such as from a third party website, file sharing network, etc.). The user can then install the validation application software on their computer for validation of there content in order to purchase soft copies of the digital media content that they own. Once downloaded, the user will no longer have a need to re-download the software on future visits to the enabled retailer's website, retail outlet, kiosk, or upon accessing a P2P network, although it will be recognized that a new download can be enforced for each such visit, such as to ensure that the latest updates (including those relating to fraud prevention, encryption, etc.) are present in the application for each use thereof.

At step 308 the user will provide their digital media content to the application software. The digital media content can be introduced to the computing device as a physical media through any number of media interfaces including CD or CD-ROM drives, DVD drives, USB drives, etc. The application software will either prompt the user to make the digital media content available to the software (e.g. by inserting a disc into a disc drive, etc.) or alternatively, the application software will already have access to the digital media content (i.e. the application software will be installed directly onto the digital media content itself).

At step 310, and in one embodiment, “fingerprint” data will be received from the original digital media content database at a processing or validation server, or alternatively an end user device. As was previously discussed, this “fingerprint” data will be generated by one or more validation procedures performed by a digital processor. This “fingerprint” data generation, as previously discussed, may be performed at a variety of locations including both the digital media database/server, or at the original content owner. In alternative embodiments, step 310 may be obviated altogether should the original digital media content remain in the database and validation of the user's digital media is instead (whether in whole or as a “fingerprint”) is sent to the digital database/server for validation.

At step 312, the user digital media content is analyzed to produce a “user fingerprint” of the user digital media. The specific information needed to produce the “user fingerprint” could be controlled by the application software itself. Alternatively, the application software may communicate, directly or indirectly, with the original content database and the database may send commands to the application software telling the software which validation procedures should be invoked to produce the “user fingerprint”. If step 310 had been obviated, the “user fingerprint” may be sent via a network to the original content digital database for validation of the user digital media content.

At step 314, the “user fingerprint” is compared against the original content “fingerprint” in order to determine if the two sources match. At step 316, the validity of the user's digital media content is determined. This validity process may require, for example, a perfect match between the user's digital media and the original content, or meeting one or more other metrics used to assess validation. For example, in an alternative embodiment, the validation process may only require that the user's digital media match the original digital media within a predetermined level of accuracy. The predetermined level of accuracy can be calculated based on theoretical or empirical evidence to give confidence that the user's digital media content is in fact authentic. A sampling approach may also be utilized; e.g., 100% match is required for validation, but only for randomly selected or deterministically selected portions of the content.

At step 320, if the validity check determines that the user's digital media content is not authentic, then a user notification will be issued (e.g., a message will be sent to the user that informs the user that they may have been a victim of counterfeiting or other illegal piracy). The application software can then provide a customer service helpline number or email address in order to assist the user in addressing the issue further, should the user feel that the error message was mistaken. The application software could also forward information to the digital content owner regarding the presence of a potentially illicit copy of a copyrighted media. This can also be done in an anonymous fashion if desired, thereby maintaining the user's privacy (e.g., so as to avoid privacy issues, claims against the service provider, etc.). If registration is required prior to using or installing the software application, then this information may also be forwarded to the digital content owner. These notification functions may be performed with or without the knowledge of the user of the software application.

Additionally, mechanisms may be employed to “destroy” or otherwise render un-usable the illicit media. For example, in one approach, the media is physically rendered inoperative such as by scrambling portions of the data on a magnetic media (e.g., HDD), or disabling portions of an optical media via e.g., laser irradiation. In another embodiment, steganographic or other data (e.g., watermarks) can be embedded within the media to mark it as illicit on any subsequent use (e.g., displaying a red “ILLEGAL COPY” notice when played back on a video rendering device, or drop-outs or tones in an audio recording).

At step 318, if the user's digital media content is validated, then the user will gain access to soft copies of the user's digital media content for purchase, perhaps for a small nominal fee, or alternatively as a free “bonus” or incentive for legitimate ownership of the media. This transaction may occur entirely over a network so that a user may request a soft copy via download. A plurality of formatting options may be provided to the user so that they can utilize the digital content in a variety of ways. For example, if the user owns a music compact disc of their favorite album, the user may request to purchase or otherwise obtain digital MP3 music files of the album so that they can enjoy the album on their personal MP3 player. As an alternative example, the user may own a DVD of a feature length film but desire to purchase a soft copy of the film for storage on a personal media center computer for later viewing or for downloading to a mobile phone or portable media player, etc. After validation of the authenticity of digital content, a softcopy of the digital media may be downloaded directly to the media center, etc. Different coding/decoding (“codec”) options may also be employed. As used herein, the term “codec” refers to an video, audio, or other data coding and/or decoding algorithm, process or apparatus including, without limitation, those of the MPEG (e.g., MPEG-1, MPEG-2, MPEG-4, etc.), Real (RealVideo, etc.), AC-3 (audio), DiVX, XViD/ViDX, Windows Media Video (e.g., WMV 7, 8, or 9), ATI Video codec, or VC-1 (SMPTE standard 421M) families.

In some embodiments, the available options for a user can be altered dynamically by the server based on information from the medium as well as information determined at the time of the request including time, location, past purchase history, PC Platform (Apple/Macintosh, Windows, Linux, etc) choices by the user and type of content. Further, the system may recognize where a piece of media was purchased based on the unique characteristics of that piece of media as it may have been made unique for a certain retailer, location, region, or other purpose.

In another embodiment, application software for creating alternative digital formats of the user's digital media will be installed locally at the end user device. By validating the user's digital media, an unlock or security function will allow the application software to perform the conversion function. The user may then purchase or otherwise obtain (for compensation, consideration or otherwise) the ability to unlock features of their software application so that copies of their digital content can be created.

It will be appreciated that, apart from the validation procedures described herein, other security approaches may be applied consistent or concurrent with such validation so as to provide a stronger “end-to-end” process if desired. For example, in one variant of the invention, AES or DES encryption is applied to all communication links between the database 204 and any computer acting as a validation entity. As is well known, untrusted networks such as the Internet may open transmitted validation or fingerprint data to attacks or corruption as man-in-the-middle attacks (e.g., one entity posing as another), data integrity attacks (i.e., corruption or modification of data during transit), and so forth. Hence, encryption, VPN tunneling, or the like can be employed to increase the confidence level and protection associated with such data during transmission.

Similarly, any number of well known authentication protocols or methods can be utilized to authenticate entities before sensitive data is transmitted over wireline or wireless links. For example, the well known IEEE-Std. 802.1x protocol can be utilized consistent with e.g., a RADIUS server of the type well known in the art to authenticate entities. Myriad other approaches will be recognized by those of ordinary skill provided the present disclosure.

Validation Procedures

As previously discussed with regards to FIGS. 1-3, validation procedures include a wide variety of apparatus and methods for determining the validity or legality of a given digital media content. Validation procedures, when implemented in the proper context, provide owners of original works the means to allow the legitimate copying and distribution of digital content on a limited basis by consumers while preventing or discouraging illegal piracy of copyrighted works. Using one or more validation schemes on a given original digital media content, one may create a so-called digital “fingerprint” of the original media or content. By comparing the “fingerprint” of a user's digital media to the “fingerprint” of an original digital media, the authenticity of a given media can be determined. Validation procedures include, but are not limited to, the following exemplary methods and procedures. More than one validation procedure maybe used in tandem and/or combined to increase the accuracy of detecting original digital media.

Hash of One or More Files—A basic “hash” is calculated using a hash algorithm and based on a pre-determined or random selection of files and/or a subset of files at validation time. In effect, the hash value acts as a “fingerprint” for a given data set. The hashing algorithm may also be specified from a supported list at validation time. The random selection method allows the server to specify a list of files known to be present on authentic media at the time of the validation request and a hashing algorithm known to be supported by the software based on its version. This minimizes the likelihood of pre-calculating hashes by attackers having access to a single authentic copy. Because hashing algorithms are deterministic in nature, if two data files are compared using the same hashing algorithm and the data files differ in any way, the output of the hashing algorithm for the two data files will be different.

Hashing uses industry standard algorithms such as RC4, RC5, Tiger, RIPEMED, and SHA-1 to create a statistically unique number based on one or more files or byte ranges within one or more files. In the SHA-1 algorithm for example, the examined data set is “flattened” and “chopped” into data “words” of a predetermined size. These words are then mixed or combined with one another using pre-determined mathematical functions. The range (i.e. “hash value”) is made to be of a definite size (e.g. 160 bits) through the use of modular division. As previously discussed, even minute differences in the source content (e.g. screeners content vs. authentic production content) will be present in the content of a pirated version of authentic media. Comparing a hash of authentic files, even of short duration (e.g. 30 second) will reveal non-exact pirated media rapidly. However, pirated media made directly from original production media may require further validation. This is because two or more data files when placed through the hashing algorithm may produce the same output, although this does not necessarily guarantee that all copies are authentic.

A multi-level approach may also be used, such as where the “fingerprinting” process (e.g., hash) is performed in two or more stages. For example, a “hash of a hash” can be performed, as can a hash of a mathematical permutation or operation of the content elements (e.g., instead of hashing a given piece of data, the data and another piece of data (unhashed or otherwise) can be e.g., added together, and then hashed. Similarly, two hashes can be added or operated upon, and then hashed again. Any number of such variations will be evident to those of ordinary skill given the present disclosure.

Audio/Video Watermarking—Another validation technique which can be used either alone or in combination with the aforementioned hashing algorithm is the concept of “watermarking”. Watermarking is well known to those of ordinary skill, and may be embodied in various approaches such as well-known digital watermarking data of the type authorized under the United States Digital Millenium Copyright Act (DMCA). For example, Digimarc®, SysCoP™, EIKONAmark™, and other similar commercially available watermarking approaches can be used. Media rights management systems such as the Microsoft Windows® Media Digital Rights Manager (DRM) may be used as well. The application of two digital watermarks, where one is strong, and the other one weak (see e.g. U.S. Pat. No. 6,591,365 entitled “Copy protection control system” issued Jul. 8, 2003, the contents of which are incorporated by reference in their entirety herein) may also be used to further validate the authenticity of a given piece of media. The weak watermark will be engineered to exist only in the “original” content.

Any compression performed on the original content would invalidate or destroy this weak watermark. This is particularly useful in that most pirated media requires some compression in order for it to be placed on a usable medium for a user. Furthermore because the weak watermark is created “programmatically”, it would be extremely unlikely that such a watermark could be re-created via known pirating techniques such as a “camcord” session, or via unauthorized “taping” of an audio event such as a concert, etc. Further enhancing the strength of this validation technique is that even if such an unlikely event were to occur, it is unlikely that a matching “strong” watermark would be produced at the same time.

Burst Cutting Area—The Burst Cutting Area (“BCA”) is an area on certain optical media that can be serialized to be unique per piece of media, or per title. In one embodiment specified under Annex H of the DVD physical specification (Standard ECMA-267, 3rd Edition—April 2001, “Standardizing Information and Communication Systems—120 mm DVD—Read-Only Disk”), incorporated herein by reference in its entirety, a bar code is provided that is individually written to replicated DVDs in the area (i.e. 22.3 mm +0.0/−0.4 mm and 23.5 mm±0.5 mm) inside of the lead-in area. The BCA is created by a very powerful laser (e.g. YAG or CO₂) that burns and/or darkens the aluminum or other reflective metal layer on the DVD. Because these darkened marks have decreased reflectivity, the marks can be used to encode information related to the origin of the digital medium. The marks are essentially stripes, roughly 10 microns wide by 1200 microns long. Because discs can be given a unique code, the unique code can be used for copy protection or serialization systems.

This code can contain up to 188 bytes of data. Players which are capable of reading BCA, read the BCA by rotating the disc at a constant angular velocity (e.g. 1440 rpm), moving the optical pickup to the BCA area and focusing on the information surface. Using a special decoding circuit (decoding the much lower frequency barcode signal than a normal DVD HF signal) reveals to the player the underlying unique code. The marks are detected as a drop-out in the HF signal. Note that there is a requirement for DVD-ROM drives to support the “Mount Fuji” specification (“Advanced Access Content System (AACS), HD DVD and DVD Pre-recorded Book”, Revision 0.9.11, Mar. 13, 2006), incorporated herein by reference in its entirety, which includes a provision to read BCA info within the “read disc info” command. While DIVX (“Digital Video Express”) format makes use of BCA, many DVD Video players do not read BCA.

Medium Type/Book Type—The DVD specification supports both ReadOnly media, such as that created by CD/DVD replicators, as well as writeable media of the type that users can use at home with commonly available DVD “burners”. The Book Type can be used as a further validation by checking for the presence of a Book Type of a pre-determined four (4) bit number. Many devices will use this Book Type field to determine how the media should be treated. The Book Type values are as follows:

| Book Type Value | Digital Media Type |
|---|---|
| 0000 | DVD-ROM |
| 0001 | DVD-RAM |
| 0010 | DVD-R, DVD-R DL |
| 0011 | DVD-RW |
| 1001 | DVD+RW |
| 1010 | DVD+R |
| 1101 | DVD+RW DL |
| 1110 | DVD+R DL |

While determining the Book Type value can give clues to the source of the content, whether original or otherwise, certain DVD burning applications will allow the user to change the Book Type of DVD+R/W media prior to creating a DVD, thus limiting its usefulness in validating content. As such, and to increase robustness, this validation should be performed with other validation procedures. While this is currently not possible with DVD−R/W, this may be reversed with DVD+R/W media.

File Sizes—Another validation procedure that provides a rather simple check involves checking the file size of one or more of the files present on the digital medium. While it is possible for a pirate of music, video or software to adjust the length of non-original files using padding or some other techniques, in practice, it is unlikely that this will occur. In addition, most content provided on optical media uses a plurality of files, thus increasing the reliability of this check when used to validate multiple files on a tested digital medium.

File Manifest—In addition to one or more other validation schemes, or alternatively issued as the lone validation procedure, the server may query the client software for a complete list of files on the digital medium as a means for validating file authenticity. This method can be particularly effective as many pirated copies of digital media often do not contain an entire set of files from an original media and obviate unnecessary files. In addition, it can be expected that for media with a large number of files, this validation procedure can become more reliable.

Content Scrambling System Presence—Virtually all commercially produced media by major content owners use some form of encryption for the content on the media. The most common system is a Content Scrambling System (CSS) used on many DVD digital media. CSS uses a proprietary 40-bit encryption stream cipher algorithm to encode content on a digital media. By detecting the presence of CSS protected content on the medium, some level of original content validation can occur. Further, both (re)writable DVD formats require the manufacturers of the media to prevent users from writing valid CSS data. In the case of DVD+R the CSS area of the media is pre-written at the factory with useless data. In the case of DVD−R the burner hardware is required to write unusable data to this area at the time of DVD burning. By checking these areas it is often possible to tell if the media has valid CSS protection.

Regional Settings—The DVD-Video specification allows content owners to establish geographical regions in which a DVD is allowed to be played back. This technique has been come to known as “regional lockout”. Manufacturers of consumer electronics such as DVD players are required to set the regional code for players destined for a given region. Regardless of the hardware setting the detection of a given Region Codes presence on a particular DVD can be used for further validation. By correlating the region code with other data such as the file hashing which may vary on media destined for different regions due to different audio tracks, subtitles, editing for content, etc., it is often possible to determine with a higher degree of certainty if a piece of media is authentic. Many pirated videos have had their Region Codes removed to make it easy for their purchasers to play in any DVD player, not just DVD players locked to the region they were destined for.

Wobble Track/ATIP Detection—Another validation procedure useful in distinguishing between so-called burned copies and pressed originals is known as Absolute Time in Pre-groove (“ATIP”) detection. On a pressed disc, the timing information that is necessary to control the disc's rate of spin is included in each CD sector as data. But for a writable disc commonly used with commercial DVD or CD burners, the CD recorder must have some way to guide the recording laser and control the speed of the blank disc as it is being recorded. For burned copies of discs the polycarbonate layer on writable discs has a spiraled groove that is modulated with a wobble.

This is where the “wobble” in wobbled pre-groove provides substantial utility. The wobbled pre-groove is modulated into the spiral and provides tracking and timing information for the recording laser. The wobble is a slight sinusoidal wave that has an “excursion” of 0.03 mm from the center of the track path. The wobble guides the recorder and provides timing information. It ensures that data is recorded at a constant rate. The resulting data track obliterates the wobbled pre-groove, leaving recorded data in its place. Thus, by checking for the presence of a Wobble Track it is possible to ascertain if the medium is pressed or burned. As original commercial copies are most often pressed for economic efficiency, illegitimate or pirated copies can be singled out by looking for these tell-tale characteristics indicating the method used to produce the digital media.

Disc Application Codes—The disc application codes are used to distinguish between discs used for different applications. The two main application codes used are “Discs for Unrestricted Use” and “Discs for Restricted Use.” For example, by using such application codes, only blank media bearing the “Compact Disc Digital Audio Recordable” (CD-DA Recordable) and “Compact Disc Digital Audio Rewritable” (CD-DA Rewritable) logos can be written using consumer audio recorders. Specifically, a Disc Application Code embedded within the ATIP information of a CD-DA Recordable/Rewritable disc's pregroove wobble indicates that it is specifically for audio use, and recording devices reject discs not containing the correct code. Within the “Disc for Restricted Use” code, additional encoded identification may be used for special disc applications. One example of this would be a Photo CD. The presence of a Disc Application Code will typically indicate that the physical media is of a recordable variety. As such it can be used in the detection of a non pressed disc.

CD Track Length/Count/Spacing Information—Because content on original media will vary from content to content, analyzing the layout information of digital media allows owners of content to determine the authenticity of the content being validated. In this way information related to the layout of content on the physical media can be used as a means for identifying the content. In one embodiment, the number, order and length of individual tracks on a CD with sub-second (frame level) resolution can be used to accurately identify the source of a CD. Due to the nature of digital copying, this layout information is unlikely to persist across many forms of duplication making this validation procedure an efficient means for validating authenticity.

CD Q Track Data—Certain data in the CD format can be used for piracy detection. This includes the Serial Copy Management System flag. This flag indicates that a pure digital copy can be allowed once, is prohibited, or is unrestricted. The vast majority of pirated CDs or those burned from peer-to-peer (P2P) networks have this bit set to unrestricted. Conversely virtually all commercial CDs sold have this flag set to “allow once” or “prohibited”. Therefore by checking this value against a known original copy, one can determine albeit with somewhat lesser reliability, the validity of the content that is being validated.

DVD Chapter Length/Count/PUO/PUOP Information—Similar to CD Track Length/Count/Spacing Information a DVD has a specific layout for any given commercial version (given a region, format (Full Screen, Wide Screen, etc)) that will consist of overall run-time, a specific number of chapters, “bonus content”, and often trailers for upcoming theatrical or DVD release. PUOPs or so-called “prohibited user operations” are used to require the user to view a particular piece of content—often the trailers, and almost always warnings regarding piracy. The information regarding the layout on the media can be fingerprinted, as well as the specific timings and locations of the chapter marks. This information, and in particular the trailers for upcoming content is often removed or not included on pirated media.

Third Party Content Protection Detection—In addition to protection standards such as CSS, AACS, and other technologies, content owners often utilize non-standard protection technologies provided by a third party. These technologies are often used to supplement the baseline content protection system included in the standard. Typically they are used after breaches occur in the standard. For instance, RipGuard manufactured by Macrovision® Corporation, is a digital rights management technology which disrupts ripping software, thereby rendering such software functionally useless in making legal and or illegal copies of digital content.

Sony® Corporation's ARccOS technology is an encryption system that is used in conjunction with CSS. The ARccOS system deliberately creates a number of sectors on the DVD containing corrupted data that causes DVD copying software to produce errors that are fatal to the later use of the copied DVD. Most, if not all, DVD players do not ever read these corrupted sectors as they follow a set of instructions encoded on the disc telling them to skip over them. Therefore, many DVD ripping utilities will indiscriminately read every sector on the disk including the corrupted data sectors thereby rendering copied digital content useless.

Myriad other third party solutions are available which offer various methodologies for digital rights management of digital content. Therefore, for each original content digital media, based on e.g. title and region, it is possible to know if any third party content protection has been selected by the content owner/distributor and a validation may be developed for its presence. The exemplary application of the present invention is also ideally made updateable to include checks for the technologies listed above, as well as being capable of detecting new third party technologies developed in the future (i.e., backwards compatible and integrated).

Receipt Corroboration Information—In addition to using physical and digital fingerprints present on the physical media, and additional layer of security and capabilities can be provided via a dynamic lookup of a customers purchase via a computer network and interaction with a retailers point-of-sale, or e-commerce system. In this scenario, the user maybe prompted to select the retail entity, location, etc. that the original digital media content was purchased from (or this maybe determined via other means such as pattern matching on the transaction numbers, information from the physical media itself, consulting a third-party database, or other mechanism), first and last name, their transaction identifier (sales order number, purchase order number, etc), some portion of a credit card number, bank card number, or other financial payment data used to purchase the digital media, and possibly the date of purchase (or range of dates during which it may have been purchased). By using querying the retailers computer systems, it is possible in some instances to determine if in fact the digital media content was purchased legitimately. This combined with validation of the presence of the actual original media enhances the overall accuracy and allows for additional options to be presented to the user (e.g., discounts and reward programs for repeat purchases, etc). This approach also allows the retailer to encourage on-going sales in the non-physical/digital market place.

Business Methods

In addition to those methods already discussed, other possibilities exist for providers and distributors of digital content in terms of business methodologies and implementations. For example, in one exemplary business method, the aforesaid system may be implemented such that a “coupon” or stored value token can be created at the time of purchase, or stored on the digital media itself. In this way, a user of this invention may be directed to a specific retailer based on information contained in the coupon and/or the digital media, or this could alternatively be determined by the server at the time of validation. The user will then be introduced to the services provided by the retailer, perhaps prompting the user to utilize the services of that retailer for other content that doesn't necessarily contain or come with such a coupon or token. Further, retailers could be chosen based on such factors as geographic location, media type, etc.

In another business method, an online retailer of digital content may generate revenue off the distribution of copies of digital content via advertising or other means without directly charging the user for downloading secondary versions of the user's digital content. After a user's digital media content has been validated, the user may be given several options for downloading “soft copies” of the original digital content. The user may then be asked to provide information, e.g., fill out a profile and perhaps fill out a short survey. This profile can then be used for various purposes such as for marketing demographics, targeted advertisements and perhaps even the monitoring of counterfeiting trends. In one embodiment of the present business method, the content and a user's profile can be used for the purpose of targeted advertising that can be aimed at the user of the download service. Costs for running the servers and computers for providing these soft copies, and potentially for the payment of licensing fees to owners of the digital content, can be paid directly by those companies seeking to target advertise to the users of this service.

In yet another business method, the soft copy material can actually be stored on the physical media itself. This is viewed as being useful, particularly with relation to some analogous issues surrounding rights management in the context of content delivery on “premium channels” such as HBO, Starz, etc. Some of these content delivery contracts prohibit the storage of purchased content on central server of sorts during certain content availability windows. Essentially for the time period that these premium channels have rights, the retailers and distributors are more limited in how they can sell the same content to users. By providing the soft copy on the physical medium itself, the content owners can bypass at least one issue that was intended to prevent cable companies or other network operators from operating “content lockers”, where users could own movies that would be stored on a central server. For example, if the media is already available in the market without soft copy, then the content must be delivered within a prescribed period (e.g., 24 hours) of purchase if the content is in one of the “windows”.

Essentially, content sources (e.g., movie studios) implement multi-year deals with a premium channel operator such as HBO, Starz, etc. in which the premium channel pays significant fees for time-restricted access to all the studios content for a period of years (e.g., 2 or more years). Typically, the access window is opened after theatrical and DVD releases, and in parallel with the Pay-Per-View (PPV) release window (or slightly delayed with respect thereto). The access window extends beyond the PPV window, and the content source (studio) is prevented from offering “downloads” of the content—this approach was initially intended to block out cable or satellite “video on demand” (VOD) systems wherein the content might be downloaded to a Set Top Box (STB). Conversely, if the “electronic” copy is disposed on the DVD itself, it can't be downloaded during these window periods.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A digital rights management apparatus, comprising:
a computerized device; and
an application running on said computerized device and adapted to validate the authenticity of a first version of a digital media and in response to said validation, allow a user to obtain a second version of said digital media.

2. The digital rights management apparatus of claim 1, wherein said first version of said digital media comprises a physical medium and said second version of said digital media comprises a soft copy.

3. The digital rights management apparatus of claim 2, wherein said physical medium comprises an optical media.

4. The digital rights management apparatus of claim 1, wherein said computerized device comprises a computing device system in a client-server relationship.

5. The digital rights management apparatus of claim 4, wherein said application comprises a distributed application.

6. The digital rights management apparatus of claim 4, wherein said application runs on the client side of said client-server relationship.

7. The digital rights management apparatus of claim 1, wherein said second version of said digital media is resident on a server.

8. The digital rights management apparatus of claim 1, wherein said validation comprises performing a cryptographic hash of at least a portion of said digital media.

9. The digital rights management apparatus of claim 1, wherein said first version comprises an optical pressed medium, and said validation comprises evaluating wobble-track information.

10. The digital rights management apparatus of claim 1, wherein said first version comprises a compact disc (CD), and said validation comprises evaluating serial copy management system flag information.

11. The digital rights management apparatus of claim 1, wherein said validation comprises the application of two digital watermarks, wherein one of said watermarks exists only in an original version of said digital media.

12. The digital rights management apparatus of claim 8, wherein said validation further comprises the application of two digital watermarks, wherein one of said watermarks exists only in an original version of said digital media.

13. The digital rights management apparatus of claim 1, wherein said validation comprises detecting the presence of valid content scrambling system protected content on a physical medium, without actually accessing content scrambled by said scrambling system.

14. The digital rights management apparatus of claim 1, wherein said validation comprises evaluating at least two (2) types of information associated with said media, said at least two (2) types of information selected from the group consisting of: (i) cryptographic hash information; (ii) audio or video watermarking information; (iii) burst cutting area information; (iv) medium or book type information; (v) file size information; (vi) file manifest information; (vii) content scrambling system presence information; (viii) regional settings information; (ix) wobble track detection information; (x) disc application codes information; (xi) CD track length, count, or spacing information; (xii) CD Q-Track information; (xiii) DVD chapter length, count, or PUO/PUOP information; and (xiv) receipt corroboration information.

15. The digital rights management apparatus of claim 1, wherein said validation comprises evaluating at least three (3) types of information associated with said media, said at least three (3) types of information selected from the group consisting of: (i) cryptographic hash information; (ii) audio or video watermarking information; (iii) burst cutting area information; (iv) medium or book type information; (v) file size information; (vi) file manifest information; (vii) content scrambling system presence information; (viii) regional settings information; (ix) wobble track detection information; (x) disc application codes information; (xi) CD track length, count, or spacing information; (xii) CD Q-Track information; (xiii) DVD chapter length, count, or PUO/PUOP information; and (xiv) receipt corroboration information.

16. A method of validating the authenticity of a digital media provided by a user, comprising:
providing said digital media to an application, at least a portion of said application running on a computing device;
generating a first characterization of said digital media using said application;
evaluating said first characterization of said digital media in light of a second characterization in order to authenticate said digital media; and
providing one or more options to said user should said digital media be authenticated.

17. The method of claim 16, wherein said application comprises a distributed application.

18. The method of claim 16, wherein said second characterization is resident on a server, said server in a client-server relationship with said computing device.

19. The method of claim 18, wherein said first characterization of said digital media comprises the result of a hashing algorithm performed on said digital media.

20. The method of claim 19, wherein said first characterization of said digital media comprises performing one or more validation operations in addition to said hashing algorithm.

21. The method of claim 16, wherein at least one of said first and second characterizations of said digital media are performed using an optical pressed medium, and said evaluating comprises evaluating wobble-track information.

22. The method of claim 16, wherein at least one of said first and second characterizations of said digital media are performed using a compact disc (CD), and said evaluating comprises evaluating serial copy management system flag information.

23. The method of claim 16, wherein at least one of said evaluating comprises evaluating the presence of at least one of two digital watermarks, wherein one of said watermarks exists only in an original version of said digital media.

24. The method of claim 16, wherein said evaluating comprises detecting the presence of valid content scrambling system protected content on a physical medium.

25. The method of claim 16, wherein said one or more options comprises permitting access to a soft copy of said digital media to said user.

26. A physical medium operable with a digital rights management system, comprising:
digital content; and
at least a portion of a validation application, said validation application operable to authenticate said digital content, thereby permitting a user to retrieve a soft copy of said digital content upon authentication of said digital content.

27. The physical medium of claim 26, wherein said physical medium comprises an optical media.

28. The physical medium of claim 27, wherein said at least a portion of said validation application is adapted to auto-run once inserted into a computing device.

29. The physical medium of claim 27, wherein said validation application comprises a distributed application.

30. The physical medium of claim 26, wherein said validation application is adapted to compare at least a portion of said digital content with at least a portion of an authenticated digital content, said at least a portion of an authenticated digital content resident on a server.

31. The physical medium of claim 26, wherein said validation application comprises a cryptographic hashing algorithm.

32. The physical medium of claim 31, wherein said hashing algorithm is utilized to create a hash of said digital content, said validation application comparing said hash with a corresponding hash generated using a similar algorithm applied to original content.

33. The physical medium of claim 26, wherein said validation application is configured to, when run, evaluate at least two (2) types of information associated with said content, said at least two (2) types of information selected from the group consisting of: (i) cryptographic hash information; (ii) audio or video watermarking information; (iii) burst cutting area information; (iv) medium or book type information; (v) file size information; (vi) file manifest information; (vii) content scrambling system presence information; (viii) regional settings information; (ix) wobble track detection information; (x) disc application codes information; (xi) CD track length, count, or spacing information; (xii) CD Q-Track information; (xiii) DVD chapter length, count, or PUO/PUOP information; and (xiv) receipt corroboration information.

34. A method of doing business, comprising providing, pursuant to a purchase or sales transaction, a physical medium operable with a digital rights management system, the medium comprising digital content; and
providing a coupon or stored value token for said purchase or sales transaction, said coupon or token allowing a purchase of said physical medium to utilize content authentication services over a network.

35. The method of claim 34, wherein said act of providing a coupon or stored value comprises providing said coupon or stored value on the physical medium itself.

36. The method of claim 34, wherein said act of providing a physical medium comprises providing at least a portion of a validation application on said medium, said validation application operable to authenticate said digital content, thereby permitting a user to retrieve a soft copy of said digital content upon authentication of said digital content.

37. The method of claim 34, wherein said coupon or stored value is associated uniquely with a particular retailer or sales entity.

38. A method of doing business, comprising generating revenue related at least in part to the distribution of copies of user's previously purchased digital content without charging the user for downloading secondary versions of the user's digital content.

39. The method of claim 38, wherein said revenue is generated based at least in part on user-provided profile or demographic information, said information being provided as part of said downloading;
wherein said information is used at least for substantially targeted advertising, said advertising generating said revenue for an on-line provider that provides said distribution of said copies.
